(19) United States
(12) Patent Application Publication
(10) Pub. No.: US 2011/0282848 A1
(43) Pub. Date: Nov. 17, 2011

(54) METHOD FOR ESTABLISHING A DATA SEQUENCE FOR GENERATING A TRIP

(75) Inventor: Jean-Marc Godart, Mons (BE)

(73) Assignee: DECIZIUM, Mons (BE)

(21) Appl. No.: 13/129,713

(22) PCT Filed: Nov. 17, 2009
(86) PCT No.: PCT/EP2009/065342

§ 371 Date: Aug. 4, 2011

(30) Foreign Application Priority Data
Nov. 17, 2008 (BE) 2008/0625

(51) Int. Cl. G06F 17/30

(52) U.S. Cl. 707/690; 707/E17.007

(57) ABSTRACT

Method for establishing, by means of a computer, a data sequence for generating a trip, the said method comprising the use of a first set of N data, each data item (POIᵢ; 1≦i≦N) identifying a point of interest that may form part of trips, with each data item (POIᵢ) of the said first set of data there being associated a first identifier (Lₚ; 1≦p≦P; P≦N) identifying a geographical location where the point of interest identified by the data item (POIᵢ) is situated, these data being structured in a database by means of the first identifier, the said database indicating, between on each occasion a first pair ((Lᵣ,Lⱼ); 1≦r≦P; 1≦j≦P) of geographical locations, a distance (Δdᵣⱼ) and a time (Δtᵣⱼ) for going from the geographical location Lᵣ to the geographical location Lⱼ.

The present invention concerns a method for establishing, by means of a computer, a data sequence for generating a trip, the said method comprising the use of a first table in which a first set of N data is stored, each data item (POIᵢ; 1≦i≦N) identifying a point of interest that may form part of trips, the said method also comprising the reception of user data introduced by a user and that relate to the trip to be established.

Such a method is known from the article by Jean-Marc Godart entitled “Combinatorial optimization based decision support system for trip planning” published in International conference on information and communication technologies in tourism, Innsbruck 1999, Springer Verlag Austria 1999, pages 318-327. According to the known method the user introduces user data relating to the trip that he envisages making. These user data and the data stored in the first table are used for preparing a trip.

One drawback of the known method is that it is not obvious to effectively produce a trip from this first set of data.

The aim of the invention is to produce a method for establishing, by means of a computer, a data sequence for generating a trip, the said method making it possible to structure the data so as to obtain rapid treatment of the method not giving rise to a long wait for the user.

To this end a method according to the invention is characterized in that the user data are correlated with the points of interest in order to take from the first table a first subset of F (F≦N) data identifying points of interest correlated with the user data, and in that, with each data item (POIᵢ) of the said first set of data, there is associated a first identifier (Lₚ; 1≦p≦P; P≦N) identifying a geographical location where the point of interest identified by the data item (POIᵢ) is situated, the said method also comprising the use of a database indicating between on each occasion a first pair ((Lᵣ,Lⱼ); 1≦r≦P; 1≦j≦P) of geographical locations, a distance (Δdᵣⱼ) and a time (Δtᵣⱼ) for going from geographic location Lᵣ to geographical location Lⱼ, the said use of the database being made by forming, from the first subset of F data, a second subset of G (G≦F; G≦P) first identifiers repeating the first identifiers associated with the data set out in the first subset, and on each occasion forming a second pair ((Lₚ)ₖ, (Lₚ)ₘ; 1≦k≦G; 1≦m≦G) of first identifiers by means of the first identifiers set out in the second subset, the said pairs ((Lₚ)ₖ, (Lₚ)ₘ) of first identifiers then being used to take from the database on each occasion the distance (Δ(dₚ)ₖₘ) and the time (Δ(tₚ)ₖₘ) for going from the geographical location (Lₚ)ₖ to the geographical location (Lₚ)ₘ, a first matrix G×G being constructed by putting at each point (k,m) the distance (Δ(dₚ)ₖₘ) and the time (Δ(tₚ)ₖₘ) taken from the database, the data of the first subset of data next being used to form the third pairs of data (POIₚ)_{q}, (POIₚ)ₛ (1≦q≦F; 1≦s≦F) and to form a second matrix F×F by taking, from the first matrix for each pair of data (POIₚ)_{q}, (POIₚ)ₛ by means of their first identifier ((Lₚ)ₖ, (Lₚ)ₘ associated on each occasion with the data (POIₚ)_{q}, (POIₚ)ₛ, the distance (Δ(dₚ)ₖₘ) and the time (Δ(tₚ)ₖₘ) and putting at each point (q,s) the distance (Δ(dₚ)ₖₘ) and the time (Δ(tₚ)ₖₘ) taken from the first matrix, the said sequence of data next being constructed by means of the distance (Δ(dₚ)ₖₘ) and the time (Δ(tₚ)ₖₘ) present in the second matrix F×F for each of the pairs (POIₚ)_{q}, (POIₚ)ₛ. Associating a first identifier with each data item makes it possible to establish a link between the point of interest and the geographical location where this point of interest is situated. As, in addition, different points of interest may be situated at the same location, the use of the first identifiers makes it possible to limit the number of elements to be processed subsequently. Use of the database makes it possible to store the distances and times effectively, since they are stored by making use of a structure based on the first identifiers. By using only the first identifiers forming part of the second subset in order to access the database when the trip is formed, the time for executing the method is considerably reduced, which contributes substantially to the efficacy of the method. From the first matrix, the second matrix can be formed quickly, which makes it possible to return to these points of interest selected on the user database and therefore to form the sequence of data for generating the trip.

A first preferential embodiment of a method according to the invention is characterized in that each first identifier (Lₚ) is formed by a distinct numerical value (LocIDₚ), an index value (index-w) is associated with each of the first identifiers (Lₚ), the said index value indicating the position of each first identifier in an arrangement of the first identifiers carried out on the basis of the said numerical value, the said database comprising a third matrix that is structured and addressed by means of this index value and contains the distance and time of each of the first pairs. Thus the database can be addressed by means of the index values, which affords a more structured and therefore quicker management.

A second preferential embodiment of a method according to the invention is characterized in that, on the basis of the numerical values forming the first identifiers, a second identifier (MaxLocID) is formed indicating the highest numerical value attributed to a first identifier, a second table comprising a number of locations at least equal to the numerical value of the said second identifier then being formed, all the first identifiers then being run through and, for each of the first identifiers, a predetermined value is put at the place the position of which in the second table corresponds to the numerical value attributed to the first identifier considered, the number of places in the second table where such a predetermined value is set out then being counted in order to form a third identifier (NumL). This makes it possible to structure all the first identifiers.

A third preferential embodiment of a method according to the invention is characterized in that a third table is formed, the number of places corresponds to the number indicated by the third identifier, the said index value (index-w) being associated with the first identifiers by placing the first identifiers in the third table in the order in which they are set out in the second table, the index value attributed corresponding to the order of succession according to which the first identifiers are set out in the third table. This makes it possible to attribute the index values by a simple logic.

A fourth preferential embodiment of a method according to the invention is characterized in that, for the second subset, the said index value is also set out in this second subset, and in that the said second pairs are formed by the index values attributed to the first identifiers forming the said second pairs. Thus it becomes possible to address the database by means of the index value also for the first identifier set out in the second subset.

A fifth preferential embodiment of a method according to the invention is characterized in that a fourth table having a number of places equal to the second identifier is formed, each of the first identifiers set out in the second subset then being set out in the fourth table at the place the position of which corresponds to the numerical value attributed to the first indicator considered, the said first identifiers set out in the fourth table then being replaced by their index value. This makes it possible to logically group the first identifiers of the second subset.

A sixth preferential embodiment of a method according to the invention is characterized in that the database comprises a third set comprising the first adaptation factors for introducing into the said sequence an adaptation according to the locomotion means used for travelling the said distance. Thus the trip sequence can be modulated according to the locomotion means used for travelling the said distance.

The invention will now be described in more detail by means of drawings that illustrate a preferential form of a method according to the invention. In the drawings:

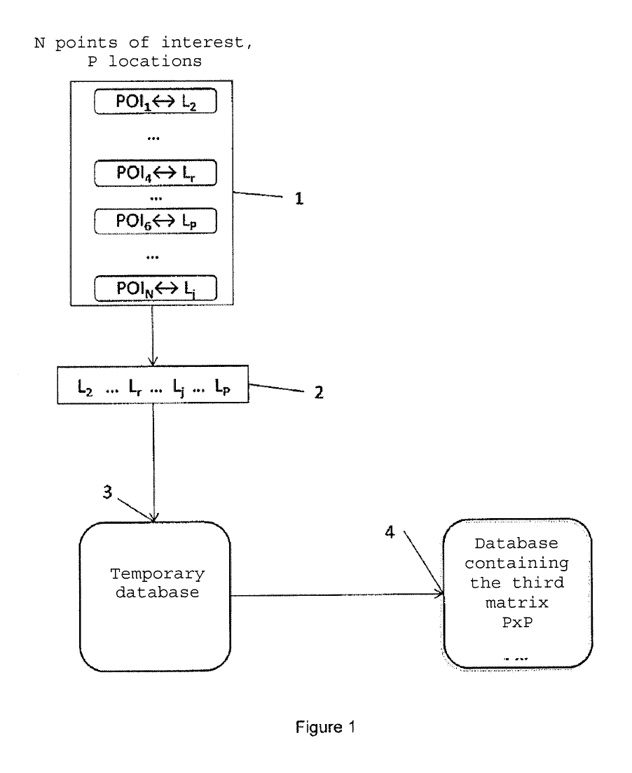

FIG. 1 illustrates the various phases of constructing the database;

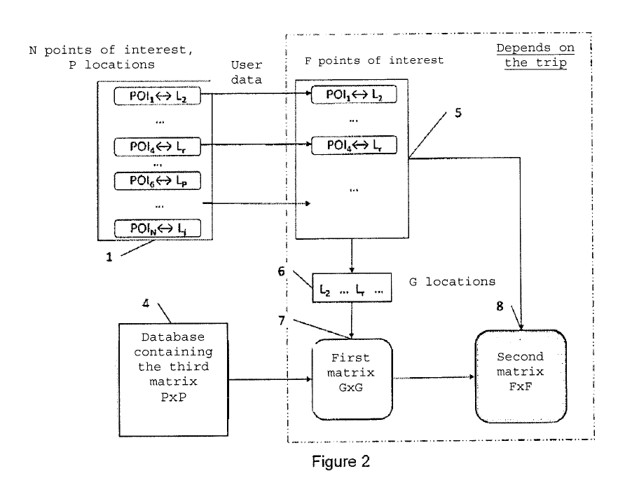

FIG. 2 illustrates the various phases of constructing the second matrix used for evaluating the data sequence; and

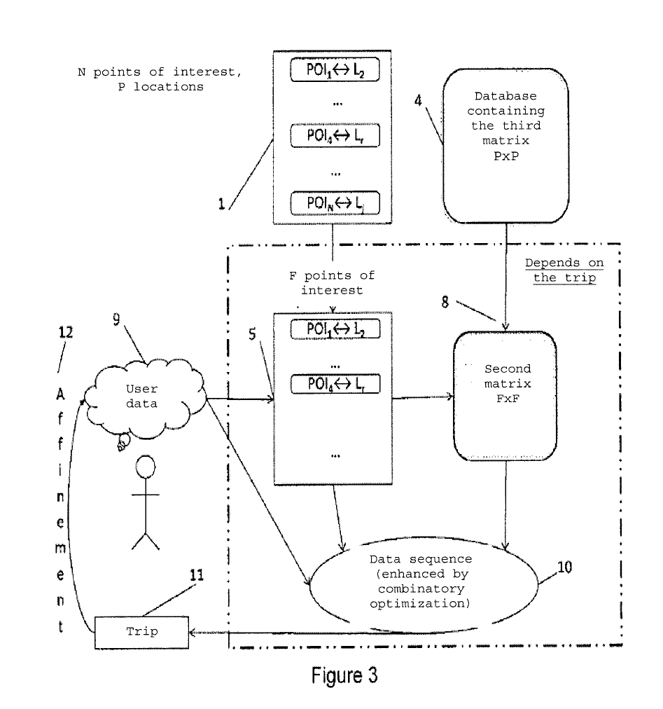

FIG. 3 illustrates the various steps of the method according to the invention.

In the drawings the same reference has been attributed to the same element or to a similar element.

Planning the trip of a tourist or of a user consists of selecting and combining, in a trip, the most appropriate tourist products by taking into account the centers of interest, the desiderata and the tourist constraints. By way of illustration, let us envisage various tourist products, namely the accommodation (hotels, bed and breakfast, campsites, etc) and activities (museums, amusement parks, hikes, etc). Thus a trip will among other things be composed of a point of origin, activities, accommodation and a destination point. These various types of element will be designated by the term points of interest (POI). Naturally the journeys between the points of interest making up a trip are also managed in the method according to the invention. It goes without saying that the invention is not limited to the points of interest cited by way of example and that naturally other embodiments can be envisaged.

In order to produce a trip the method according to the invention has recourse to a database the structure of which will be described by means of FIG. 1. As described previously the generation of a trip requires points of interest (POI) that may form part of the trip. It is therefore necessary to group together and store these points of interest. For this purpose the method according to the invention has recourse to a first table 1 in which a first set of N data (POIᵢ), is stored, each data item (POIᵢ; 1≦i≦N) identifying a point of interest. Each point of interest is linked to a geographical location indicating where it is situated geographically. The location of a point of interest is for example defined by its longitude and latitude. This information concerning the geographical location is necessary for constructing the trip in order to be able to take into account the travel from one point of interest POIₓ to another point of interest PIO_{y}. For this purpose there is associated with each data item (POIᵢ) of the said first set of data a first identifier (Lₚ; 1≦p; P≦N) identifying the geographical location where the point of interest identified by the data item (POIᵢ) is situated. Let P≦N be explained by the fact that, at the same geographical location Lₚ, there may be more than one point of interest. Thus for example in an amusement park situated at geographical location L₅ there may be an hotel POI₃, a theater POI₉ and an attraction POI₁₁. After having attributed a first identifier to each geographical location, a second set of P first identifiers is obtained.

According to the invention the information relating to the journeys during a trip are calculated from a database 4 of structured journeys in an adapted and generally gigantic fashion, which may for example take the form of one or more direct-access computer files. This structured database contains the journey distances Δd and times Δt for all the possible journeys between all the pairs of geographical locations 2 situated in the first table of points of interest. It should be noted that here it is the information relating to the journeys between two geographical locations rather than between two points of interest. The database 4 is constructed by indicating between on each occasion a first pair ((Lᵣ,Lⱼ); 1≦r≦P; 1≦j≦P) of geographical locations in the second subset a distance (Δdᵣⱼ) and a time (Δtᵣⱼ) for going from the geographical location Lᵣ to the geographical location Lⱼ.

In order however to allow easy access to this database it is important to put a logical structure in the way of storing therein the distance and time for each of the first pairs. This technique obviously makes it possible to reduce the size of the journey database. The volume required for these data does however remain high and requires a large memory space. In addition, only a small part of these data will actually be used during the construction of a trip requested by the user. It must however be emphasized that several databases of journeys could be used simultaneously, for example for different countries or regions, in order to limit the size of each of them.

The first identifier is for example each time formed by a distinct numerical value (LocID). This distinct numerical value is preferably a positive value. The set of these geographical locations constitutes the second set of P (P≦N) geographical locations. For each first pair of first identifiers ((Lᵣ,Lⱼ); 1≦r≦P; 1≦j≦P), the distance and duration of a journey between this pair of locations are then calculated.

For reasons of clarity, it has been chosen to calculate a single journey for each pair of first identifiers. This is quite obviously not restrictive and with a few modifications several journeys (or no journey) between a pair of first identifiers (Lᵣ,Lⱼ) could be envisaged, such as for example with no means of access from Lᵣ to Lⱼ, the shortest journey and the quickest journey from Lᵣ to Lⱼ, etc. The database may where applicable comprise, for a predetermined number of points of interest, an evaluation coefficient for evaluating the interest of the point of interest in question. These evaluation coefficients may be a cost and/or a measurement of attractiveness associated with a point of interest in question. If for example the point of interest concerns an attraction the cost will be the entry price, if the point of interest concerns accommodation the cost will be the tariff per night. This coefficient of interest will be taken into consideration when the sequence used for producing the trip is generated. An adaptation of the sequence according to the locomotion means (car, aircraft, train, etc) used for travelling the said distance is also possible.

The temporary database 3 therefore contains the distance (Δdᵣⱼ) and time (Δtᵣⱼ) information for going from the geographical location Lᵣ to the geographical location Lⱼ. This database of the distances and times of the journeys may for example take the form of a computer file. The structure of this file is as follows:

| | | | |
|---|---|---|---|
| L₁[T] | L₂[T] | Δd(1 ,2)[T] | Δt(1, 2)[LB] |
| L₁[T] | L₃[T] | Δd(1, 3)[T] | Δt(1, 3)[LB] |
| L₁[T] | L₄[T] | Δd(1, 4)[T] | Δt(1, 4)[LB] |

and so on for all the journeys from L₁ to all the other Ls,

| | | | |
|---|---|---|---|
| L₂[T] | L₁[T] | Δd(2, 1)[T] | Δt(2, 1)[LB] |
| L₂[T] | L₃[T] | Δd(2, 3)[T] | Δt(2, 3)[LB] |
| L₂[T] | L₄[T] | Δd(2, 4)[T] | Δt(2, 4)[LB] |

and so on for all the journeys from L₂ to all the other Ls, and for all the combinations of L.

In the above example, [T] symbolizes a tabulation, [LB] the return, Δd(r,j) the distance from the geographical location Lᵣ to the geographical location Lⱼ, and Δt(r,j) the time taken to move from the geographical location Lᵣ to the geographical location Lⱼ. It should be noted that the order of lines in this file has no importance. In order to construct the temporary database, for each pair of points of interest the distance (Δd) and the transit time (Δt) between their respective geographical locations are calculated. To do this it has been chosen to use for example a specific commercial tool, offered by the company GeoSolutions (Opti-Time), for transport by road (car, walking, bicycle, etc). However, other tools could perfectly well be used to do this. In particular, any tool that includes a road database (of the TeleAtlas or NavTech type) and a shortest-path algorithm (well known) can be substituted for the one adopted. The calculation of an approximate distance and transit time can also be substituted, for example calculated “as the crow flies”.

From this temporary journey data structure, the database for the journeys in a structured format 4 will be constructed. This structured database will contain the following elements:
a second identifier called MaxLocID, the numerical value of which is equal to the maximum numerical value, that is to say the one that is the highest numerical value (LocIDₚ) attributed to a first identifier present in the second set;
a third identifier called NumL, the numerical value of which is equal to P, which indicates the total number of first identifiers used present in the database under construction;
an index value (index-w), which indexes the first identifiers present in the database under construction;
a third matrix P×P that contains the distances and durations of the journeys between the first identifiers taken in pairs present in the temporary database.

In order to form these second and third identifiers, the temporary database, namely the computer file, is run through a first time in order to verify the consistency of the data, that is to say that each of the numerical values (LocID) attributed to the first identifiers are positive and the distances and times are consistent. The second identifier (MaxLocID) is determined by seeking, among the first identifiers, the one that has the highest numerical value. This highest numerical value is then stored.

The following step is the determination of the third identifier (NumL), which is determined by counting in the second set the number of first different identifiers actually present in the temporary database. This is because, if for example the second identifier is equal to MaxLocID=7, it may very well be that some numerical values have not been used for the first identifiers. Thus, for example, it may be that there is no first identifier having the numerical value L=3. It would then be unnecessary to store data concerning this first identifier L=3.

In order to calculate the third identifier (NumL), a second table comprising a number of places at least equal to the numerical value of the said second identifier is formed. The places being numbered in increasing order. The temporary database 3 is next run through and, for each of the first identifiers present in this temporary database, a predetermined value is put at the place the position of which in the second table corresponds to the numerical value attributed to the first identifier considered. This is for example done by storing, when the second table is formed, an initial value (for example 0) in each of the places in the second table. When the temporary database is next run through, when a path going from the first identifier Lᵣ to the first identifier Lⱼ is read, a predetermined numerical value (for example 1) is written in these places in the second table, the serial numbers of which correspond to the numerical values attributed to the first identifiers Lᵣ and Lⱼ. The number of places in the second table where such a predetermined value (1) is entered then being counted to form the third identifier (NumL). This third identifier will preferably be stored in the database.

For example, if MaxLocID=7 and the numerical values of the first identifiers present in the temporary database are 1, 4, 5, 6 and 7, then the second table will have seven places all initialized to the value 0 as set out in the example below:

| 0 | 0 | 0 | 0 | 0 | 0 | 0 |
|---|---|---|---|---|---|---|
| 1 | 2 | 3 | 4 | 5 | 6 | 7 |

Since the numerical values 2 and 3 are not present in the example considered, running through the temporary database will then give:

| 1 | 0 | 0 | 1 | 1 | 1 | 1 |
|---|---|---|---|---|---|---|
| 1 | 2 | 3 | 4 | 5 | 6 | 7 |

Counting the number of places in the second table containing the predetermined numerical value 1 supplies a value P=NumL of the third identifier. In the example, P=5.

An index value (index-w) will be associated with the first identifiers present in the second table, the said index value indicating the position of each first identifier in an arrangement of the first identifiers carried out on the basis of the said numerical value, in particular the order of arrangement in the third table would be used for this purpose. The index value of the first identifier will be the place or position that it occupies in the arrangement of the first identifiers present in the computer file. To create this index value, the third table will be formed comprising P places, the places in the third table being numbered in increasing order. The number of places in the third table corresponds to the number indicated by the third identifier NumL. The said index value (index-w) being associated with the first identifiers by placing the first identifiers in the third table in the order in which they are set out in the second table, the index value attributed corresponding to the order of succession according to which the first identifiers are set out in the third table. The third table will preferably be integrated in the database.

For each (p; 1≦p≦P) of the locations in the third table, the serial number corresponding to the p^{th} predetermined numerical value present in the second table is entered at place p in the third table. In the example described above, the third table is:

| 1 | 4 | 5 | 6 | 7 |
|---|---|---|---|---|
| 1 | 2 | 3 | 4 | 5 |

and, thus for example, the third identifier the index of which is 4 is equal to 6.

A third matrix P×P is next constructed by putting at each point (r,j) the distance (Δdᵣⱼ) and time (Δtᵣⱼ), taken from the temporary database, in order to go from geographical location Lᵣ to geographical location Lⱼ, that is to say to go from the geographical location of index r to the geographical location of index j. For example, the point (3,5) in this third matrix contains the distance and time to go from the geographical location identified by the numerical value 5 (=value of the third place in the third table) to the geographical location identified by the numerical value 7 (=value of the fifth place in the third table).

A check on the consistency of the data is made during the phase of construction of this third matrix; that is to say a check that there do not exist two journeys concerning the same pair of geographical locations with different distances and times and that journey information is available for each pair of first identifiers present in the temporary database.

It should be noted that the construction of this structured database 4 could be adapted in the case of symmetrical data, that is to say if the journey for going from Lᵣ to Lⱼ is the same as the journey for going from Lⱼ to Lᵣ.

It should be emphasized that this third matrix P×P should be modified only when all the N points of interest are modified, or the distance or time between two geographical locations changes. It is independent of the trips calculated.

To construct a trip, the user will have recourse to a user interface, the role of which is in particular to obtain from the user the information essential to the construction of a trip adapted to his expectations. This interface is preferably an internet site intended for the general public. Obviously other technologies can be envisaged (mobile interface, etc), intended for the general public or professionals. By means of this interface, the user will introduce user data 9 that relate to the trip to be established. Before obtaining a first trip proposal, the user will simply have to reply to a few questions, or introduce data such as the destination or destinations, the accommodation and the attraction or attractions which he wishes to form part of the trip. These questions posed to the user are of course one choice among others.

For example, the user can among other things determine:
1. the region or regions that he wishes to visit;
2. the starting point of his trip. This starting point may or may not be fixed;
3. the dates of his trip. These dates may be defined in a fixed manner (namely a precise trip period), or these dates may be flexible (namely a minimum number of trip days, a maximum number of trip days and a more or less wide trip period);
4. the form of his trip:
   a circular trip, namely a trip commencing and terminating at the same point,
   a linear trip, namely a trip not necessarily finishing where it began;
5. if the trip is linear, the point of arrival of the trip may or may not be fixed.

It goes without saying that the invention is not limited to all these criteria and that they are mentioned by way of example, but naturally other embodiments can be used.

On the basis of the replies or data introduced, namely the user data, the user interface will correlate them with the points of interest POI stored in the first table 1 and will select and take, from all the N points of interest POI stored in the first table, a first subset of F(F≦N) points of interest 5 POIᵢ, which will be used in the construction of a trip adapted to the desiderata of the user, as illustrated in FIG. 2. As a first identifier Lₚ is associated with each of the points of interest, it will also be selected. Thus for example the following points of interest are selected:
the potential origins of the trip, that is to say a town (or village) or airport fixed by the user, that is to say some of the towns (or villages) or airports present in the first table 1;
the activities that may be followed during the trip, namely the activities present in the first table 1, situated in the regions to be visited and open at the dates of the trip;
the accommodation where it is possible to stay during the trip, namely the accommodation present in the first table 1, which is situated in the regions to be visited and are available at the dates of the trip;
the potential destinations of the trip, that is to say a town (or village) or an airport fixed by the user, that is to say some of the towns (or villages) or airports present in the first table 1.

All the N points of interest stored in the first table can be stored in various sub-tables. Some of these sub-tables may be internal sub-tables (local to the user interface) and others external databases. The external databases may for example be consulted through web services (for example in XML).

In particular, with regard to the accommodation, a connection by web service to an external database of hotels managed and kept up to date in real time makes it possible to know and use the actual availabilities and costs of possible accommodation. This is useful for constructing realistic trips. This is because this information changes from minute to minute.

A calculation engine receives the user data, as well as the first subset of F data. This engine will be responsible for constructing the data sequence.

Thus the following information, among others, is transmitted to the calculation engine:
the parameters relating to the constraints and objectives to be taken into account in the optimization,
the information relating to the origins,
the information relating to the activities and the opening hours thereof,
the information relating to the accommodation and the availability and cost thereof,
the information relating to the destinations.

It is obvious that some of this information could be omitted and others could be added.

The parameters relating to the constraints and objectives to be taken in to account in the optimization include among other things for example:
a value indicating whether the trip is circular or linear;
the minimum number of days in the trip;
the maximum number of days in the trip;
the period during which the user wishes to travel;
the amount not to be exceeded for the total cost of the trip;
the transport cost per kilometer.

The information relating to the origins include, among other things, for example, for each origin:
an identifier (or set of identifiers) of this origin;
the first identifier.

The information relating to the activities include, among other things, for example, for each activity:
an identifier (or set of identifiers) of this activity;
the first identifier;
the opening hours thereof;
the cost thereof.

The information relating to the accommodation includes, among others, for example, for each accommodation:
an identifier (or set of identifiers) of this accommodation;
the first identifier;
the availabilities thereof;
the prices thereof.

The information relating to the destinations include, among other things, for example, for each destination:
an identifier (or set of identifiers) of this destination;
the first identifier.

It goes without saying that the invention is not limited to all this information and that it is mentioned by way of example, but naturally other embodiments can be used.

Advantageously, the first table comprises, for a predetermined number of points of interest, an evaluation coefficient for evaluating the interest of the point of interest in question. This makes it possible, when the sequence is constructed, to use the evaluation coefficient in order to construct the said sequence and thus take account of the interest of the point of interest in question. This evaluation coefficient can thus indicate the category of an hotel, the environment (town center, country), the presence of tourist sites, etc. The evaluation coefficient can also comprise a cost associated with the point of interest in question, such as for example the tariff for spending the night. The evaluation coefficient may also comprise an attractiveness measurement associated with the point of interest in question. Thus the sequence may not only comprise this evaluation coefficient but it is also possible to use it when the sequence is established.

In the method according to the invention the calculation engine will then structure the information relating to the various journeys between the F points of interest of the first set that were selected on the basis of the data of the user, in order to construct a second matrix of the journeys 8 between these F different points of interest taken in pairs.

In order to construct the second matrix having a dimension dependent on the characteristics of the trip, the calculation engine will review all the F points of interest of the first subset. The calculation engine will reference the geographical location thereof and will adopt only the information relating to the journeys liable to be undertaken during the trip, ignoring the others.

To make the volume of work to be performed by the calculation easier and thus to obtain better efficacy, the method according to the invention comprises the formation, from the first subset 5 of F data items, a second subset 6 of G (G≦F) first identifiers repeating the first identifiers Lₚ associated with the data set out in the first subset. That G≦F is explained by the fact that, in the first subset, there may be points of interest situated at the same geographical location. The purpose of the formation of the second subset 6 is also to use, for the points of interest set out in the first subset 5, that is to say those that were selected on the basis of the user data, the first identifier that was associated therewith. Thus, by virtue of the first identifiers set out in the second subset, it becomes possible to address the database 4, which was structured by means of the first identifiers as described above. From the first identifiers Lₚ set out in the second subset, the calculation engine will on each occasion form a second pair ((((Lₚ)ₖ, (Lₚ)ₘ); 1≦k≦G; 1≦m≦G) of first identifiers.

Let us suppose, as for example set out in FIG. 2, that the first subset of points of interest liable to form part of the trip is of size 5 (F=5) and that the first identifiers associated with these points are L₁(=1), L₂(=4) and L₄(=6) (G=3):

| L₁ | L₂ | L₂ | L₄ | L₁ |
|---|---|---|---|---|
| (POIᵢ)₁/POI₁ | (POIᵢ)₂/POI₃ | (POIᵢ)₃/POI₄ | (POIᵢ)₄/POI₆ | (POIᵢ)₅/POI₈ |

The calculation engine will read the value NumL of the third identifier and the value MaxLocID of the second identifier in the database 4. Let us suppose that these values are NumL=5 and MaxLocID=7. A fourth table will then be created having a number of places equal to the second identifier MaxLocID. Each of the first identifiers set out in the second subset will then be set out in the fourth table at the place the position of which corresponds to the numerical value attributed to the first identifier Lₚ in question. The said first identifiers set out in the fourth table will then be replaced by their index value.

In practice the fourth table is first of all filled with a first constant value, for example −2.

| −2 | −2 | −2 | −2 | −2 | −2 | −2 |
|---|---|---|---|---|---|---|
| 1 | 2 | 3 | 4 | 5 | 6 | 7 |

The said first constant value would then be replaced by a second constant value −1 at these places in the fourth table where the first identifiers of the second subset are to be set out. In order to achieve this replacement the calculation engine will run through the first subset of the points of interest and take by means of the first table on each occasion the first identifier associated with the points of interest set out in the first subset. Next, for each first identifier thus taken the calculation engine will replace the first constant value with the second value −1 at all the places where the serial number of the place corresponds to the numerical value attributed to the first identifiers taken.

| −1 | −2 | −2 | −1 | −2 | −1 | −2 |
|---|---|---|---|---|---|---|
| 1 | 2 | 3 | 4 | 5 | 6 | 7 |

G = 3

When the first identifiers associated with the points of interest of the first subset are run through, the calculation engine also verifies that these are less than or equal to the second identifier MaxLocID. If such is not the case an error signal is produced. By totaling the number of second constant values in the fourth table, the number G (G≦F) is obtained equal to the number of different geographical locations that will have to be recovered in the database 4. This number G forms a fourth identifier.

The calculation engine then reads in the third table for each of the first identifiers set out in the fourth table the index values (index-w) associated with these first identifiers. The fourth table will be completed by introducing therein the index values of the first identifiers set out in the second subset.

To do this, for each of the first identifiers (Lₚ)ₖ (k; 1≦k≦G) read in the fourth table, if at the place having the serial number (Lₚ)ₖ the second constant value −1 is present, it is replaced by the index value attributed to the first identifier (Lₚ)ₖ.

| 1 | −2 | −2 | 2 | −2 | 4 | −2 |
|---|---|---|---|---|---|---|
| 1 | 2 | 3 | 4 | 5 | 6 | 7 |

By means of the fourth table setting out the index values of the different geographical locations that are liable to form part of the trip, the calculation engine is in a position to take from the database 4 all the distances (Δ(dₚ)ₖₘ) and times (Δ(tₚ)ₖₘ) for going from the geographical location (Lₚ)ₖ to the geographical location (Lₚ)ₘ ((Lₚ)ₖ, (Lₚ)ₘ; (1≦k≦G; 1≦m≦G). After this taking, a first matrix 7 G×G will be constructed by putting at each point (k,m) the distance (Δ(dₚ)ₖₘ) and the time (Δ(tₚ)ₖₘ) taken from the database 4. Thus this first matrix contains the distance and time between all the pairs of different geographical locations corresponding to the points of interest liable to be in the trip. The data (POIᵢ) of the first subset of data will then be used for the third pairs of data ((POIᵢ)_{q}, (POIᵢ)ₛ (1≦q≦F; 1≦s≦F) where q and s represent a numbering in the first subset. The point of interest (POIᵢ)_{q} representing the one having the serial number q in the first subset. In the example set out above, (Δd(3,2)) is the distance for going from the geographical location L₄ to the geographical location L₂.

The first matrix, which is structured by means of the first identifiers of the second subset, will then be used to form a second matrix F×F. This is because, since at least one point of interest is associated with each first identifier, it suffices to take for each pair of data ((POIᵢ)_{q}, (POIᵢ)ₛ) of the first subset by means of their first identifiers ((Lₚ)ₖ, (Lₚ)ₘ) the distance ((Δdₚ)ₖₘ) and the time (Δ(tₚ)ₖₘ). The first matrix is then formed by putting at each point (q,s) the distance ((Δdₚ)ₖₘ) and the time (Δ(tₚ)ₖₘ) that have just been taken.

Thus, for example, the duration of the journey between the fourth point of interest POI₆ and the second point of interest POI₃ in the set of points of interest liable to form part of the trip is stored in the component (3,2) of the second matrix G×G. The data sequence for generating the trip will then be constructed by means of the distance ((Δdₚ)ₖₘ) and the time (Δ(tₚ)ₖₘ) present in the second matrix F×F for each of the pairs ((POIᵢ)_{q}, (POIᵢ)ₛ). Now the calculation engine will very quickly be able to find the information relating to a journey to be made during the trip.

A trip is essentially characterized by its (ordered) sequence of points of interest and possibly by other variables necessary for optimization. It must satisfy a certain number of constraints and is evaluated according to one or more objectives. Clearly, in order to fully characterize a trip, it suffices to know the (ordered) sequence of points of interest that make it up and are set out in the first subset, as well as the times at which the visit to these points of interest commences and ends. Thus, for each trip constructed, the following elements that characterize this trip are recorded, namely the sequence of the points of interest that constitute the trip and the time of the start of the visit to each of the points of interest that constitute this trip as well as the time necessary for this visit.

The first component in the sequence of points of interest refers to the point of interest belonging to the first subset of data that was chosen as the origin of the trip. The following components contain, in the order of appearance thereof in the trip, the references to the points of interest (activities and/or accommodation) belonging to the first subset of data that constitute the trip. The last component in the sequence of the points of interest refers to the point of interest belonging to the first subset of data that was chosen as the destination of the trip.

A trip must satisfy a certain number of constraints. This is because the global parameters and some information supplied to the calculation engine (hours of opening, availability, etc) result in constraints that must be complied with by each trip. Thus for example it is possible to have a constraint related to the maximum budget: the sum of the cost of the trip must not exceed the maximum budget supplied by the user.

By way of example elements that can be used as a basis for evaluating a trip are now presented. The quality of a trip can be evaluated according to various criteria (objectives). Two main objectives are for example taken into account: minimizing the costs of the various components of the trip and maximizing the attractiveness (that is to say the interest) of the various components of the trip. The attractiveness is a measure of the interest of a point of interest. The measurements of compromises defined by the user are used to define weightings relating to each of the objectives.

The calculation engine constructs a trip adapted to the expectations of the user starting from a simple initial trip constructed on the basis of the sequence of data 10 obtained as described above, and then improves it through an optimization process.

It should be noted that the reasoning method applied by the technology is opposed to the reasoning that a person skilled it the art would have if he were to construct a trip by himself and therefore design a computer system that would make it possible to automate this process. This is because he would no doubt have a tendency to choose a few activities and accommodations that please him and then attempt to organize them in order to distribute them in different days in order to obtain directly a more or less adapted trip, which he would then be able to attempt to improve by visiting a few additional activities, deciding to eliminate others, replacing one accommodation with another, etc, the whole by trial and error.

However, the trip obtained would then be greatly dependent on his first choices. Moreover, this process may be difficult to automate. Contrary to this, from a very simple tip project, more freedom is left to explore more varied trails, and it is easy to automate the implementation of a large number of iterative improvements. The technology according to the invention evaluates millions of different trips in a few seconds. A traveler would not be able to compare as many trips in an entire life.

This trip 11 is presented, for example day by day, to the user, accompanied by useful information (descriptions, photographs, etc). The user can also view each day of the trip, as well as the complete trip, on a map. If the trip proposed does not perfectly suit the user, he has the possibility of specifying or reviewing his wishes 12 and constructing a new trip. These choices will be taken into account when a new trip is constructed, since they correspond to precise parameters or data sent to the calculation engine.

For example, before constructing a new trip, the user can express his preference vis-à-vis activities proposed in the current trip. If an activity does not interest him, it will suffice for him to exclude it from the next trips (activity not sent to the calculation engine). On the other hand, if an activity interests him, he will be able to request that it absolutely be placed in the next trip. The user can also exclude from the next proposals an accommodation that does not suit him (accommodation not sent to the calculation engine). Conversely, he can request placing an accommodation that suits him in the next trip proposals. Likewise, the number of times (nights) during which the user wishes to stay in this accommodation may be specified. The user can indicate his centers of interest, which will determine the selection of the activities. The user also has the possibility of running through the data in the first table corresponding to activities for the purpose of including some of these activities in his next trip. The same thing is possible for the accommodation.

From a technical point of view, many tests are carried out in order not to enable a user to make inconsistent choices. When the user has refined his request, he requests the construction of a new trip. The system then sends the updated information to the calculation engine, which generates an adapted new trip. The new trip is then proposed to the user. This trip can be refined until the user is satisfied with the trip proposed.

1. Method for establishing, by means of a computer, a sequence of data for generating a trip, the said method comprising the use of a first table in which a first set of N data is stored, each data item (POIᵢ; 1≦i≦N) identifying a point of interest that may form part of journeys, the said method also comprising the reception of user data introduced by a user and that relate to the trip to be established, the said user data being correlated with the points of interest in order to take from the first table a first subset of F (F≦N) data identifying points of interest correlated with the user data, characterized in that, with each data item (POIᵢ) of the said first set of data, there is associated a first identifier (Lₚ; 1≦p≦P; P≦N) identifying a geographical location where the point of interest identified by the data item (POIᵢ) is situated, the said method also comprising the use of a database indicating between on each occasion a first pair ((Lᵣ,Lⱼ); 1≦r≦P; 1≦j≦P) of geographical locations, a distance (Δdᵣⱼ) and a time (Δtᵣⱼ) for going from geographical location Lᵣ to geographical location Lⱼ, the said use of the database being made by forming, from the first subset of F data, a second subset of G (G≦F, G≦P) first identifiers repeating the first identifiers associated with the data set out in the first subset, and on each occasion forming a second pair (((Lₚ)ₖ, (Lₚ)ₘ; 1≦k≦G; 1≦m≦G) of first identifiers by means of the first identifiers set out in the second subset, the said pairs ((Lₚ)ₖ, (Lₚ)ₘ) of first identifiers then being used to take from the database on each occasion the distance (Δ(dₚ)ₖₘ) and the time (Δ(tₚ)ₖₘ) for going from the geographical location (Lₚ)ₖ to the geographical location (Lₚ)ₘ, a first matrix G×G being constructed by putting at each point (k,m) the distance (Δ(dₚ)ₖₘ) and the time (Δ(tₚ)ₖₘ) taken from the database, the data of the first subset of data next being used to form third pairs of data (((POIᵢ)_{q}, (POIᵢ)ₛ (1≦q≦F; 1≦s≦F) and to form a second matrix F×F by taking, from the first matrix for each pair of data ((POIᵢ)_{q}, (POIᵢ)ₛ) by means of their first identifier (Lₚ)ₖ, (Lₚ)ₘ associated on each occasion with the data (POIᵢ)_{q}, (POIᵢ)ₛ, the distance (Δ(dₚ)ₖₘ) and the time (Δ(tₚ)ₖₘ) and putting at each point (q,s) the distance (Δ(dₚ)ₖₘ) and the time (Δ(tₚ)ₖₘ) taken from the first matrix, the said sequence of data next being constructed by means of the distance (Δ(dₚ)ₖₘ) and the time (Δ(tₚ)ₖₘ) present in the second matrix F×F for each of the pairs (POIᵢ)_{q}, (POIᵢ)ₛ.

2. Method according to claim 1, characterized in that each first identifier (Lₚ) is formed by a distinct numerical value (LocIDₚ), an index value (index-w) is associated with each of the first identifiers (Lₚ), the said index value indicating the position of each first identifier in an arrangement of the first identifiers carried out on the basis of the said numerical value, the said database comprising a third matrix that is structured and addressed by means of this index value and contains the distance and time of each of the first pairs.

3. Method according to claim 2, characterized in that, on the basis of the numerical values forming the first identifiers, a second identifier (MaxLocID) is formed indicating the highest numerical value attributed to a first identifier, a second table comprising a number of places at least equal to the numerical value of the said second identifier then being formed, all the first identifiers then being run through and, for each of the first identifiers, a predetermined value is put at the place the position of which in the second table corresponds to the numerical value attributed to the first identifier considered, the number of places in the second table where such a predetermined value is set out then being counted in order to form a third identifier (NumL).

4. Method according to claim 3, characterized in that a third table is formed, in which the number of places corresponds to the number indicated by the third identifier, the said index value (index-w) being associated with the first identifiers by placing the first identifiers in the third table in the order in which they are set out in the second table, the index value attributed corresponding to the order of succession according to which the first identifiers are set out in the third table.

5. Method according to claim 3, characterized in that a temporary database is formed on the basis of the first identifiers attributed to the points of interest, the said temporary database is formed by taking on each occasion a pair of first identifiers with which on each occasion there are associated the distance and the time taken to go from the geographical location Lᵣ to the geographical location Lⱼ set out in the pair, the said temporary database being run through when the second table is formed.

6. Method according to claim 5, characterized in that a check on the consistency of the data stored in the temporary database is performed when the temporary database is run through.

7. Method according to claim 2, characterized in that, for the second subset, the said index value is also set out in this second subset, and in that the said second pairs are formed by the index values attributed to the first identifiers forming the said second pairs.

8. Method according to claim 3, characterized in that a fourth table having a number of places equal to the second identifier is formed, each of the first identifiers set out in the second subset then being set out in the fourth table at the place the position of which corresponds to the numerical value attributed to the first indicator considered, the said first identifiers set out in the fourth table then being replaced by their index value.

9. Method according to claim 8, characterized in that the said fourth table is first of all filled with a first constant value (−2), the said first constant value being replaced by a second constant value (−1) at these places in the fourth table where the first identifiers of the second subset should be entered.

10. Method according to claim 9, characterized that the number of places where the said second constant value is set out are totaled in order to form a fourth identifier indicating the number G of elements of the second subset.

11. Method according to claim 10, characterized in that fourth table is completed by introducing therein the index values of the first identifiers set out in the second subset.

12. Method according to claim 11, characterized in that, after having replaced the second constant value with the index value, it is checked whether there remain places comprising the second value and, if such is the case, an error signal is produced.

13. Method according to claim 8, characterized in that the first matrix is structured on the basis of the data set out in the fourth table.

14. Method according to claim 1, characterized in that, from the sequence of data constructed, it is changed by applying a combinatory optimization method.

15. Method according to claim 1, characterized in that the database comprises a third set comprising first adaptation factors for introducing into the said sequence an adaptation according to the locomotion means used for travelling the said distance.

16. Method according to claim 1, characterized in that the first table comprises, for a predetermined number of points of interest, an evaluation coefficient for evaluating the interest of the point of interest in question, and in that, when the sequence is constructed, the evaluation coefficient is used to construct the said sequence.

17. Method according to claim 16, characterized in that the evaluation coefficient comprises a cost associated with the point of interest in question.

18. Method according to claim 16, characterized in that the evaluation coefficient comprises a measurement of attractiveness associated with the point of interest in question.

19. Method for constructing a trip and presenting it to a user, the said method comprising the establishment of a data sequence by applying the method according to claim 1, characterized in that, from the said sequence, the trip is constructed using the points of interest set out in the said sequence and displaying them.

20. Method according to claim 19, characterized in that, after having displayed the said sequence and on the basis of adaptation data introduced by the user, a modified sequence is produced by again applying the method to establish a data sequence.

21. Method according to claim 19, characterized in that the user data comprises a compromise data item for supplementing the user data.
